(19) United States
(12) Patent Application Publication
(10) Pub. No.: US 2009/0235970 A1
(43) Pub. Date: Sep. 24, 2009

(54) Energy-storage mouse pad capable of absorbing light energy

(76) Inventor: Juei-Chao Chen, Taipei City (TW)

Correspondence Address: Juei-Chao Chen, P.O.BOX 46-563 Taipei, Taipei City 10499 (R.O.C.), Taipei, 104, TW

(21) Appl. No.: 12/229,284

(22) Filed: Aug. 22, 2008

(30) Foreign Application Priority Data
Mar. 21, 2008 (TW) 097204886

(51) Int. Cl. H02N 6/00

(52) U.S. Cl. 136/244

(57) ABSTRACT

An energy-storage mouse pad capable of absorbing light energy is provided. The energy-storage mouse pad uses a solar panel disposed on a base thereof to collect ambient light illumination energy and transform it into electric energy to be stored in a storage device, and then supplies electric power to peripheral devices of a computer via a connecting port to fully utilize power resources and saving power costs.

### BACKGROUND OF THE INVENTION

1. Technical Field

The present invention relates to an energy-storage mouse pad capable of absorbing light energy, and particularly, relates to a mouse pad structure capable of transforming ambient light illumination energy into electric energy for storage.

2. Description of Related Art

With development of science and technology and widespread availability of information, computers have become an indispensable tool for almost every modern person. Furthermore, new peripheral devices for computers, whether the desktop type or the notebook type, are also researched and developed at an ever-faster pace. Taking the mouse as an example, the earliest generation of ball mice which sense a moving position by means of a scroll ball suffers from a slow response and high failure rate. Accordingly, modern optical mice have been developed to sense a moving position by means of light, which delivers a faster response and lower failure rate. However, as an optical mouse senses a moving position by means of light, it would be difficult to use an optical mouse on a common desktop surface or a transparent material due to lack of effective reflection. In this case, the mouse pad plays a more important role. Unfortunately, common mouse pads only focus on materials, appearance and comfort level thereof without providing additional functions to facilitate use.

Accordingly, how to obviate the above problem is a technical challenge to be addressed by the present inventor.

### BRIEF SUMMARY OF THE INVENTION

In view of the shortcomings described above and by collecting relevant data and making an evaluation and consideration on all aspects of this problem, the present inventor has made repeated experiments and modifications based on years of experience in the art, and finally works out this novel mouse pad capable of transforming ambient light illumination into electric energy for storage and use.

The primary objective of this invention is that, by using a solar panel to absorb ambient light illumination energy and transform it into electric energy for storage in an energy-storage device and outputting electric power via a connecting port, the solar mouse pad can supply electric power to peripheral devices of a computer.

Another objective of this invention is that, the solar panel is further provided with a diffusion layer so that by using the diffusion layer to uniformly diffuse a portion of ambient light, the solar panel as a whole can absorb and utilize the ambient light illumination uniformly, thus achieving an optimal light absorption performance.

### BRIEF DESCRIPTION OF THE SEVERAL VIEWS OF THE DRAWINGS

The invention as well as a preferred mode of use, further objectives and advantages thereof will be best understood by referring to the following detailed description of an illustrative embodiment when read in conjunction with the accompanying drawings, wherein:

FIG. 1 is a perspective outline view of a preferred embodiment of this invention;

FIG. 2 is a perspective exploded view of the preferred embodiment of this invention;

FIG. 3 is a first applied drawing of the preferred embodiment of this invention;

FIG. 4 is a second applied drawing of the preferred embodiment of this invention;

FIG. 5 is a third applied drawing of the preferred embodiment of this invention;

FIG. 6 is a fourth applied drawing of the preferred embodiment of this invention; and

FIG. 7 is a fifth applied drawing of the preferred embodiment of this invention.

### DETAILED DESCRIPTION OF THE INVENTION

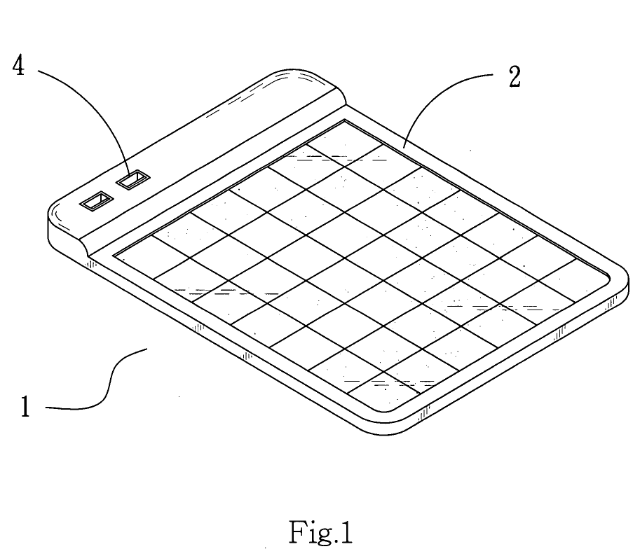

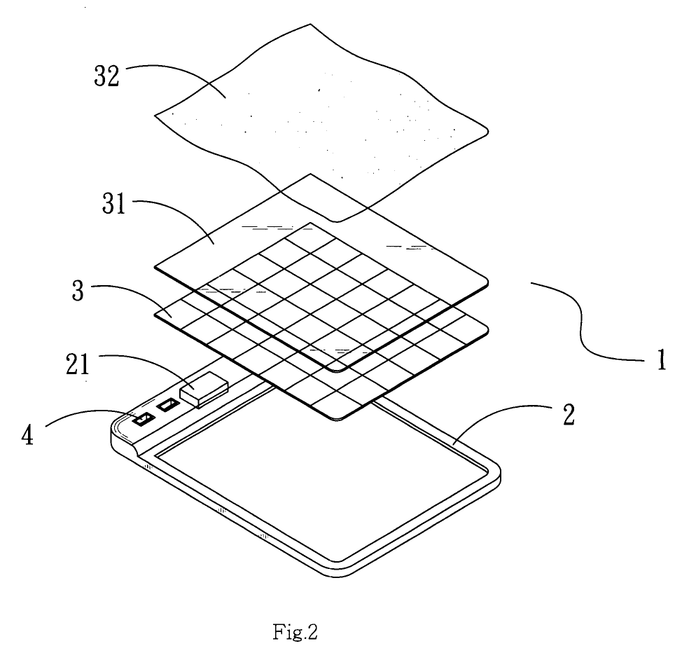

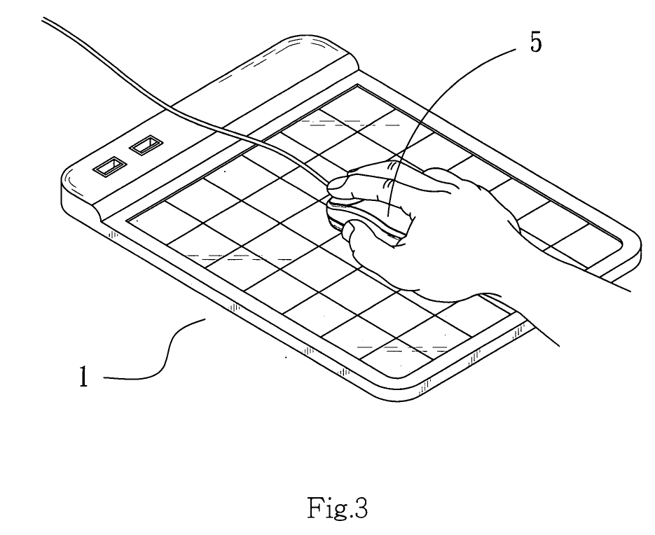

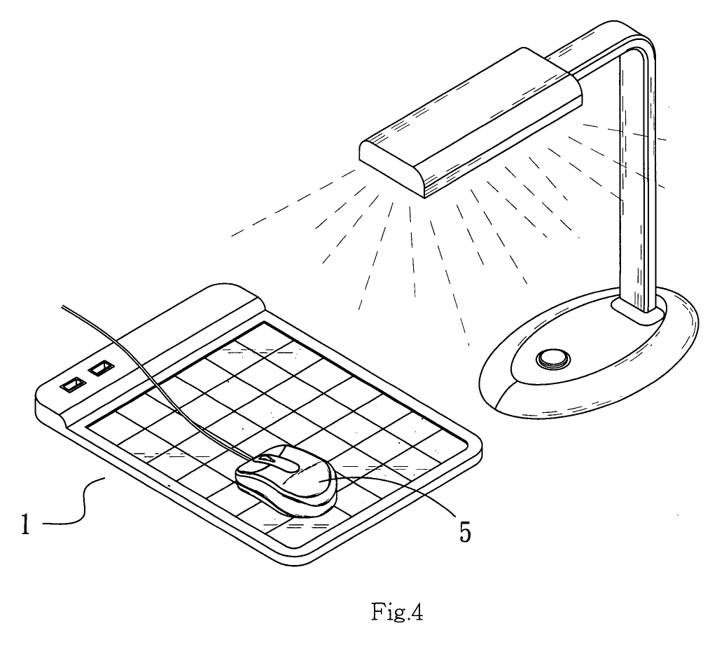

Hereinafter, the technical means and structure employed by this invention to accomplish the above objectives and functionalities will be described in detail with reference to a preferred embodiment of this invention to facilitate a thorough understanding. Referring to FIGS. 1 and 2, a perspective outline view and a perspective exploded view of a solar mouse pad 1 are illustrated therein respectively. As can be seen clearly from these drawings, the solar mouse pad 1 primarily comprises a base 2, an energy-storage device 21, a solar panel 3 and a connecting port 4. The energy-storage device 21 is disposed on the base 2. The base 2 is further provided with one or more connecting ports 4 at a side thereof, which may comply with one of the USB connection specification, the PS/2 connection specification, the RS323 connection specification, the IEEE1394 connection specification and other relevant connection specifications for electric signal transmission. Also, the base 2 is provided with a solar panel 3, which may be a monocrystal silicon solar panel, a polysilicon solar panel or an amorphous silicon solar panel complying with corresponding specifications. A diffusion layer 31 is in turn disposed on the solar panel 3, and is attached thereon with a refractive layer 32 for refracting and reflecting infrared light from the optical mouse itself back into the optical mouse. Referring to FIGS. 2, 3 and 4, a preferred embodiment of this invention is illustrated therein. As can be seen clearly from these drawings, when the solar mouse pad 1 is used with a mouse 5, the solar panel 3 disposed on the solar mouse pad 1 transforms light illumination energy from ambient table lamps, desk lamps, fluorescent lamps or other illuminating devices into electric power to be stored in the energy-storage device 21 on the base 2. Here, the energy-storage device 21 may be a nickel-hydrogen cell, a nickel-cadmium cell, a hydrocarbon cell, a lithium cell or the like that can store electric power. Furthermore, with the diffusion layer 31 disposed on the solar panel 3, ambient light illumination and sensing light from the bottom of the optical mouse 5 itself get diffused uniformly so that each part of the solar panel 3 can absorb and utilize light uniformly.

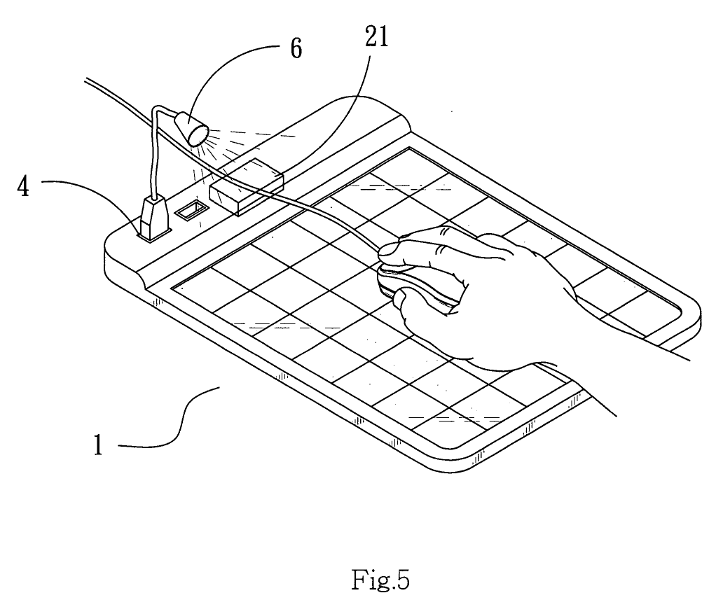

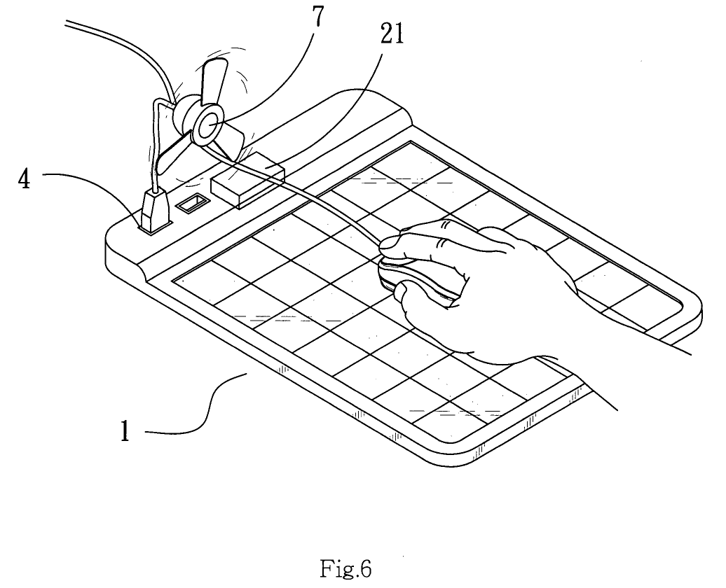

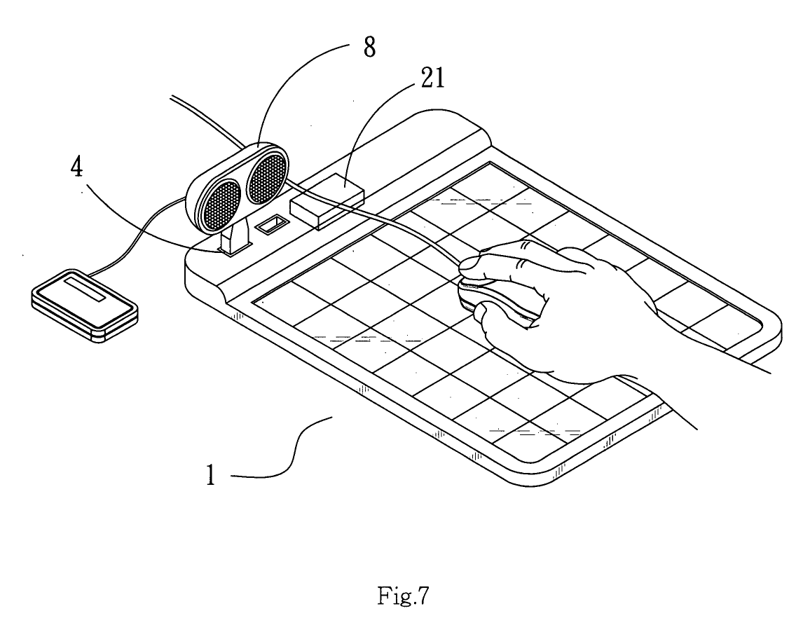

Referring further to FIGS. 5, 6 and 7, the embodiment of this invention is further illustrated therein. As can be seen clearly from these drawings, the connecting port 4 disposed at a side of the solar mouse pad 1 allows an illumination apparatus 6, a miniaturized fan 7 or a loudspeaker 8 of a playing device to be plugged therein and powered by the already charged energy-storage device 21 on the base 2. In this way, the solar mouse pad 1 is not only limited to use with the mouse, but may be further applied to some peripheral devices to achieve the goal of energy conservation and environmental protection.

1. An energy-storage mouse pad capable of absorbing light energy, comprising:
a base;
a solar panel, adapted to collect ambient light illumination energy and transform it into electric energy;
an energy-storage device for storing the electric energy generated by the solar panel upon collecting the light; and
one or more connecting ports, adapted to output the electric energy stored in the energy storage device.

2. The energy-storage mouse pad capable of absorbing light energy as claimed in claim 1, wherein the solar panel is a monocrystal silicon solar panel, a polysilicon solar panel or an amorphous silicon solar panel.

3. The energy-storage mouse pad capable of absorbing light energy as claimed in claim 1, wherein the solar panel is provided with a diffusion layer thereon, and the diffusion layer is adapted to uniformly diffuse the ambient light illumination to achieve an optimal light absorption performance.

4. The energy-storage mouse pad capable of absorbing light energy as claimed in claim 3, wherein the diffusion layer has a refractive layer attached thereon.

5. The energy-storage mouse pad capable of absorbing light energy as claimed in claim 1, wherein the energy-storage device is a nickel-hydrogen cell, a nickel-cadmium cell, a hydrocarbon cell, or a lithium cell capable of storing electric power.

6. The energy-storage mouse pad capable of absorbing light energy as claimed in claim 1, wherein the connecting port complies with one of the USB connection specification, the PS/2 connection specification, the RS323 connection specification, the IEEE1394 connection specification and other relevant connection specifications for electric signal transmission.
